(19) United States
(12) Patent Application Publication
(10) Pub. No.: US 2026/0071723 A1
(43) Pub. Date: Mar. 12, 2026

(54) Portable desktop

(71) Applicant: 16054340 Canada Inc., Oakville (CA)

(72) Inventor: Mohammad Barakat, Oakville (CA)

(21) Appl. No.: 19/323,523

(22) Filed: Sep. 9, 2025

Related U.S. Application Data
(60) Provisional application No. 63/694,075, filed on Sep. 12, 2024.

(51) Int. Cl. F16M 13/02

(52) U.S. Cl. CPC F16M 13/022

(57) ABSTRACT

A mountable device for use on a handle having a grip member at one end. The mountable device comprising a pivot, a first platform, wherein the upper surface is configured to host an object thereon, the lower surface engages the grip member, and the first end portion is attached to the pivot, a second platform, wherein the first end portion is attached to the pivot and the second end portion comprises one or more attachment surfaces configured for mounting the device to the handle thereby forming an angle at the pivot and providing the first platform with a slope, and an adjustment mechanism comprising a threaded rod and clamp, wherein the adjustment mechanism increases or decreases a distance between the clamp and the attachment surfaces thereby increasing or decreasing a slope angle between the first and second platform.

### CROSS-REFERENCE TO RELATED APPLICATIONS

This application claims priority to U.S. provisional patent application Ser. No. 63/694,075, filed Sep. 12, 2024, the content of which is hereby incorporated by reference in its entirety.

### BACKGROUND

The present disclosure relates to a mountable device for hosting an object thereon and more specifically to a device that is mountable to a handle and/or flat surface.

Working while traveling has become ubiquitous. At any airport, at any time of the day or night, one will see travelers waiting to board a plane working on their laptops. In most situations it has become a difficult to work on a laptop due to the scarcity of surfaces in which a laptop can be placed without contorting the body. For example, laptops are situated on laps while the traveler is sitting on some type of bench hunched over looking at the screen and typing. If the benches are all taken, which is oftentimes the case at the airport gate, the traveler is sitting on the floor with legs crossed and a laptop positioned somehow on the crossed legs with the traveler again hunched over looking at the screen and typing. On occasion when tired of being hunched over, the traveler may lay on the floor looking at the screen with his or her head arched up, strain the neck muscles and vertebrae. In all of these and other positions, after a while they become cumbersome and even painful.

As is often the case, the traveler has a piece of carry-on luggage alongside. Typically, the carry-on luggage has handles that extend upwardly which pose an obstacle to place a laptop in a stable position on the luggage. In addition, the top surface of any luggage Is not substantially flat and therefore difficult to put a laptop in a stable position on the luggage.

An aspect of the present disclosure relates to a mountable device for use on a handle of a suitcase or similar carrying article having two vertical members attached to a grip member at one end. The mountable device comprises a pivot, a first platform having first end portion and upper and lower surfaces, wherein the upper surface is configured to host an object thereon, the lower surface engages the grip member, and the first end portion is attached to the pivot, a second platform having first and second end portions, wherein the first end portion is attached to the pivot and the second end portion comprises one or more attachment surfaces configured for mounting the device to the handle by being configured to engage the grip member of the handle thereby forming an angle at the pivot and providing the first platform with a slope, and an adjustment mechanism comprising a threaded rod and clamp disposed on the second platform and engaging the lower surface of the first platform, wherein the adjustment mechanism increases or decreases a distance between the clamp and the attachment surfaces thereby increasing or decreasing a slope of the first and/or second platform.

A further aspect of this mountable device includes the pivot comprising aligned apertures on opposing sides with screws extending through the apertures of the first platform and the second platform respectfully. The screws are held in position by suitable threaded nuts engaging respective threads of each screw.

A further aspect of this mountable device includes the device further comprising the two vertical members being attached to a carrying article and the adjustment mechanism further comprises clamp arms that are movable between the pivot and a distal end of the first platform such that the clamp arms engage the two vertical members to retain the mountable device to the carrying article.

A further aspect of this mountable device includes the first and second platforms being configured and being pivotable with respect to each other to a nesting position.

Another aspect of the present disclosure relates to a mountable device for use on a flat surface. The mountable device comprises a pivot, a first platform having a first end portion and upper and lower surfaces, wherein the upper surface is configured to host an object thereon and the first end portion is attached to the pivot, wherein the first platform has a slope, a second platform having first and second end portions and upper and lower surfaces, wherein the first end portion is attached to the pivot and the lower surface is configured for mounting the device to the flat surface, a prop engaging the lower surface of the first platform and an upper surface of the second platform thereby providing the first platform with a slope, and an adjustment mechanism comprising a threaded rod and clamp disposed on the second platform and engaging the lower surface of the first platform, wherein the adjustment mechanism increases or decreases a distance between the clamp and the second end portion of the second platform thereby increasing or decreasing the slope of the first platform.

A further aspect of this mountable device includes the pivot comprising a rod extending through aligned apertures of the first platform and the second platform.

A further aspect of this mountable device includes the first and second platforms being configured and being pivotable with respect to each other to a nesting position.

Another aspect of the present disclosure relates to a mountable device for use on a flat surface or, in the alternative, a handle having two vertical members attached to a grip member at one end. The mountable device comprises a pivot, a first platform having a first end portion and upper and lower surfaces, wherein the upper surface is configured to host an object thereon and the first end portion is attached to the pivot, and wherein the first platform has a slope; one of: a second platform having first and second end portions, wherein the first end portion is attached to the pivot and the second end portion comprises one or more attachment surfaces configured for mounting the device to the handle by being configured to engage the grip member of the handle thereby forming an angle at the pivot, wherein the lower surface of the first platform engages the grip member and provides the slope of the first platform, and or a second platform having first and second end portions and upper and lower surfaces, wherein the first end portion is attached to the pivot and the lower surface is configured for mounting the device to the flat surface thereby forming an angle at the pivot, and a prop engaging the lower surface of the first platform and an upper surface of the second platform thereby providing the slope of the first platform; and an adjustment mechanism comprising a threaded rod and a clamp disposed on the second platform and engaging the lower surface of the first platform, wherein the adjustment mechanism increases or decreases a distance between the clamp and the second end of the second platform thereby increasing or decreasing the slope of the first platform.

A further aspect of this mountable device includes the pivot comprising a rod extending through aligned apertures of the first platform and the second platform.

A further aspect of this mountable device includes the device further comprising the two vertical members being attached to a carrying article and the adjustment mechanism further comprises clamp arms that are movable between the pivot and a distal end of the first platform such that the clamp arms engage the two vertical members to retain the mountable device to the carrying article.

A further aspect of this mountable device includes the first and second platforms being configured and being pivotable with respect to each other to a nesting position.

### BRIEF DESCRIPTION OF THE DRAWINGS

FIG. 1 is a side perspective view of a mountable device mounted to a handle according to one or more embodiments described herein.

FIG. 2 is a side view of the mountable device mounted to a handle according to one or more embodiments described herein.

FIG. 3 is a side of the mountable mounted to a handle with a laptop computer situated on the mountable device.

FIG. 4 is a perspective view of the mountable device viewing upwardly mounted it to a handle with a laptop computer situated on the mountable device.

FIG. 5 is a perspective view of the mountable device Illustrating the first platform situated on a slope.

FIG. 6 is a perspective view of the mountable device with parts thereof expanded illustrating the first platform situated on a slope.

FIG. 7 is a perspective view of the mountable device from below.

FIG. 8 is a perspective view of the mountable device from below.

FIG. 9 is a perspective view of the mountable device expanded illustrating the mountable device positioned on a substantially flat surface.

FIG. 10 is a side view of the mountable device in a nested position.

FIG. 11 is a perspective view of the mountable device in a nested position.

FIG. 12 Is a side view illustrating the mountable device in several angular slopes.

### DETAILED DESCRIPTION

Described herein is a mountable device for hosting an object thereon and more specifically a device that is mountable to a handle of a suitcase or similar carrying article or can be positioned on a flat surface. The device provides a platform having an adjustable slope such that an object positioned on the platform can be positioned at an angle and/or slope chosen by a user. For example, the device may host a laptop or book thereon, which may be positioned at a comfortable angle for a user to type, read, and/or otherwise use the object. The device may be configured to be mountable to a handle such as a telescoping handle on a suitcase or luggage, or for use on flat surfaces such as a desktop or table. The device provides a user with a portable desktop allowing the user to set up a workspace or table anywhere. The device may be configured to fold into a folded configuration such that the device is flat or substantially flat and of a size allowing the device to be easily stored and packed for portability.

The device is mountable to a mounting surface. The mounting surface may be a handle extending vertically having two vertical support members connected by a horizontal grip member at one end. The handle may be a handle extending from any object including, but not limited to, rolling laptop bags, suitcases and luggage, tool carts, golf bags, medical carts, utility carts, camping and hiking gear, hand trucks and dollies, etc. In one or more embodiments, the handle is a telescoping handle extending from a suitcase. The mounting surface may also be positioned on a non-handle surface. For example, the device may be mountable to a flat or substantially flat surface such as a table, desk, floor, etc. The device is configurable for use on a variety of mounting surfaces to provide the user with a desktop in any location, especially where there is limited table space and/or seating space.

In one or more embodiments, the mountable device comprises a first platform and a second platform connectable at a pivot point. The pivot point may be located anywhere along the length of the first and/or second platform. For example, one end of the first platform and one end of the second platform meet to form the pivot point. The first platform may extend past the pivot point when one end of the first platform meets one end of the second platform. This may provide the device and/or object with an equal weight distribution and/or stability. The pivot may allow the first platform to rotate 360 or 180 degrees about the second platform and vice versa. The pivot may comprise a rod made of any suitable material extending through aligned apertures in the first platform and the second platform and held in place with a fastening mechanism. Suitable materials may be any metal or a sufficiently rigid polymer. When the device is mounted to a mounting surface, the angle measurement of the pivot may be up to 90 degrees. The angle of the pivot may be a right angle (90 degrees), an acute angle (between 0 and 90 degrees), or zero degrees. In one or more embodiments, the pivot allows the device to fold into a folded configuration such that the first platform and the second platform lie in the same plane or substantially the same plane. In the folded configuration, the angle measurement of the pivot may be at or about zero degrees or at or about 180 degrees. In the non-folded configuration, the first platform may be configured for hosting one or more objects thereon and the second and/or first platform may be configured for mounting the device to a mounting surface.

The mountable device may further comprise one or more attachment surfaces. The one or more attachment surfaces may allow the device to be removably securable to a mounting surface, specifically a handle. The attachment surfaces may include, but are not limited to, hooks, clamps, fasteners, latches, etc. In one or more embodiments, the one or more attachment surfaces are hooks. The attachment surfaces may be connected to the second platform and configured to extend around the handle and/or grip member of the handle. In one or more embodiments, the attachment surfaces engage underneath and/or the top of the handle and/or grip member of a handle to suspend the device from the handle and/or grip member. The term “engage” as used throughout this disclosure may mean direct or indirect engagement. The attachment surfaces may have a folded position and a non-folded position. In the non-folded position, the attachment surfaces are exposed for engaging the mounting surface. In the folded position, the attachment surfaces may be foldable and/or adjustable independent of the second platform and/or device. For example, the attachment surfaces may be folded such that the attachment surfaces lie flush with and/or against the second platform and/or the device. The attachment surfaces may be folded to the folded position when the device is in the folded configuration for storage and/or portability. Additionally, the attachment surfaces may be configured to the folded position when the device is mounted on a non-handle surface.

The mountable device may further comprise an adjustment mechanism for adjusting the slope of the first and/or second platform. In one or more embodiments, the adjustment mechanism comprises a threaded rod and a clamp. In other embodiments, the drive mechanism may include any other structure capable of achieving relative linear motion, such as rack-and-pinion, belt-and-pulley, worm gear, linear actuators, or other equivalent means for producing sliding motion. The present disclosure is not limited to the illustrated mechanism, but encompasses such functionally similar arrangements. A user may adjust the slope of the first and/or second platform by rotating the threaded rod. Movement of the clamp along the length of the threaded rod may adjust the slope of the first and/or second platform. The clamp may further comprise one or more clamp arms for engaging a mounting surface and to aid in changing the slope of the first and/or second platform. For example, the clamp arms may secure the grip member of a handle tightly between the clamp arms and the attachments surfaces providing the device with stability and reducing the slope of the second platform and/or the first platform. When the grip member is secured between the clamp arms and the attachment surfaces the device may be suspended from the grip member and prevented from swinging and/or moving. When the slope of the first and/or second platform is reduced, the slope is approaching zero. When the slope of the first and/or second platform is increased, the slope is moving further away from zero. In one or more embodiments, the slope of the first and/or second platform may be zero.

In one or more embodiments, a distance between the clamp and the attachment surfaces may be shortest, which may force the second platform to be moved upwards and/or to a substantially horizontal position. This movement may be caused by the clamp pushing the second platform away from the vertical support members. The clamp arms may engage the vertical support members and/or the grip member. In one or more embodiments, the clamp may be moved away from the attachment surfaces, which may increase the distance between the clamp and the attachment surfaces and allow the second platform to drop and/or lower until the clamp arms engage the vertical members. The clamp arms may engage the vertical support members at a lower position on the handle and/or a distance away from the grip member. In one or more embodiments, the clamp may be moved away from the attachment surfaces as far back as the threaded rod and/or second platform allows, in which case the second platform may drop to its lowest position.

The mountable device may further comprise a prop to support and/or hold up the first platform. In one or more embodiments, wherein the device is mounted to a handle, the handle and/or grip member may support the first platform. However, in one or more embodiments wherein the device is mounted to a non-handle surface, the device may require a prop to prop up the first platform. The prop may include, but is not limited to, a stick, stand, and/or a wedge. In one or more embodiments, the prop is a metal frame configured for propping up and/or supporting the first platform. The proximal end portion of the prop is movable either rotationally or slidably. The prop may be configured to position the first platform at an angle and/or provide the first platform with a slope. The prop may engage the first and/or the second platform. In one or more embodiments, the prop is coupled to the clamp of the adjustment mechanism such that movement of the clamp moves the prop to adjust the slope and/or angle of the first platform. The prop may be secured to or releasably engage the first and/or second platform. For example, the prop may be secured to the first platform and releasably coupled to the second platform, clamp, and/or clamp arms. The prop may move to a folded and non-folded position. In the non-folded position, the prop may support the first platform at an angle and/or slope. Whereas, in the folded position the prop may be configured to lie flush with and/or against the first and/or second platform such that the prop lies in the same plane, or substantially the same plane, as the first and/or second platform. The folded position may be preferred in one or more embodiments wherein the device is placed in the folded configuration for storage and portability or wherein the first platform is otherwise supported, e.g., by a handle.

In one or more embodiments, the mountable device is mountable to a handle. The device comprises first and second platforms connectable at a pivot. The second platform may further comprise at least one attachment mechanism for suspending the device from the handle. For example, the attachment surfaces have a hook shape that may reach underneath a grip member of a handle and extend around the top of the grip member. The first platform may rest on the grip member and/or the attachment surfaces. When the attachment surfaces engage the handle and the first platform engages the grip member, the pivot may have an angle measuring 90 degrees or less. The first and/or second platform may have a slope.

The adjustment mechanism may be used to adjust the slope and/or angle of the device including the first and/or second platform. The adjustment mechanism may also adjust the angle of the pivot. In one or more embodiments, rotating the threaded rod in a first direction causes the clamp and/or clamp arms to move toward one end of the second platform and rotating the threaded rod in a second direction causes the clamp and/or clamp arms to move toward the pivot.

When the device is mounted to a handle, the clamp may be adjusted to move toward the handle and/or grip member thereby tightening the handle and/or grip member between the clamp and the attachment surfaces such that a slope of the first platform is reduced, and the slope of the second platform is also reduced and/or equals zero. A user may stop adjusting the device at any point when the desired slope and/or position is reached.

In one or more embodiments, the mountable device is mountable to a non-handle surface. The second platform may be configured to mount the device to the non-handle surface such that a lower surface of the second platform engages the non-handle surface. Additionally, or alternatively, the first platform may be configured to mount the device to the non-handle surface such that the first and/or second platform engages the non-handle surface. For example, the first end and/or lower surface of the first platform may engage the non-handle surface. Additionally, or alternatively, the second end and/or lower surface of the second platform may engage the non-handle surface. Engagement may be direct or indirect. In one or more embodiments, the first and/or second platform may include a mounting feature for engaging the non-handle surface. The mounting feature may be one or more surface materials. For example, the second platform may include a surface material made of a non-slip material such as silicon to prevent slipping and/or movement of the device when mounted. The mountable device may further comprise one or more props to support the first platform when the first and/or second platform is mounted to the non-handle surface. The prop may be coupled to the clamp and/or clamp arms for adjustment of the device. For example, the user may rotate the threaded rod to move the clamp and/or clamp arms along the length of the threaded rod. In one or more embodiments, moving the clamp away from a pivot toward one end of the second platform causes an end of the prop to move away from the pivot and toward the one end of the platform thereby reducing the slope of the first platform. Whereas movement of the clamp toward the pivot may increase the slope of the first platform. In one or more embodiments, the slope of the second platform does not change and remains in contact with the mounting surface.

In one or more embodiments, the mountable device is disengaged from a mounting surface. The device may fold into the folded configuration for storage and portability. In the folded configuration, the first platform may lie in the same plane as the second platform or in a substantially parallel plane. The angle measurement at the pivot may be at or about zero degrees or at or about 180 degrees. The attachment surfaces may be folded to lie flush against the second platform. The prop may be folded to lie flush against the first and/or second platform. The device may fit in a backpack, purse, laptop bag, etc.

The mountable device may be made of one or more materials and preferably materials that assist in durability, weight, and portability. In a preferred embodiment, the device is durable yet light weight for compact storage and portability. The device may be made of materials including, but not limited to, aluminum, wood, plastic, medium-density fiberboard, carbon fiber, steel or stainless steel, bamboo, fabric or foam padding, and combinations thereof.

The dimensions of the mountable device may vary. For example, the dimensions and weight are sufficient to support the size and weight of a standard laptop. In one or more embodiments, the first platform may have a length that is about 8 to 11 inches, a width that is about 6 to 10 inches, and/or a height that is about 0.3 to 2 inches. The second platform may have a length between about 3 to 6 inches, a width between about 3 to 5 inches, and/or a height that is about 0.3 to 2 inches. The dimensions of the second platform may be configured to fit within the dimensions of the first platform when in the folded configuration.

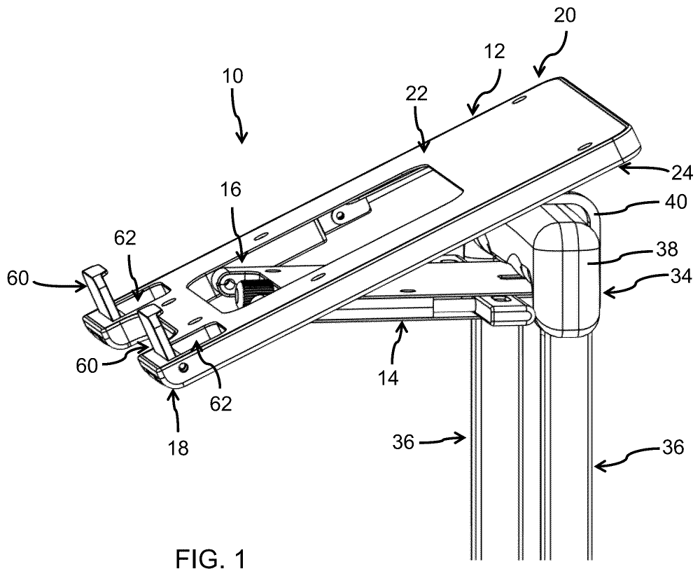

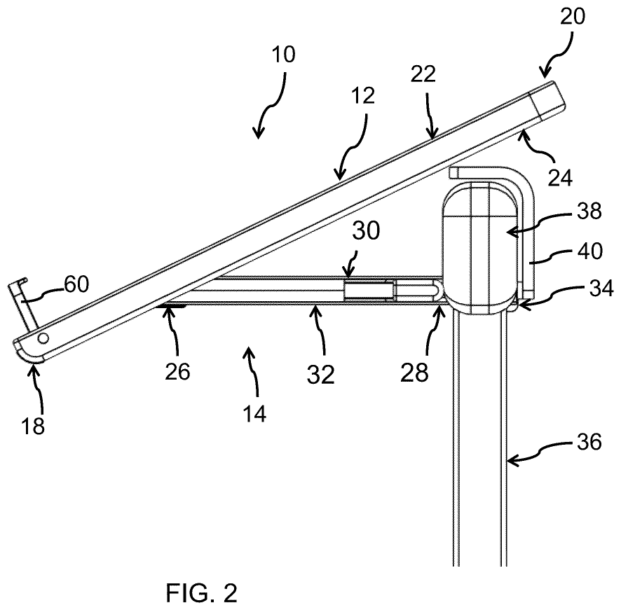

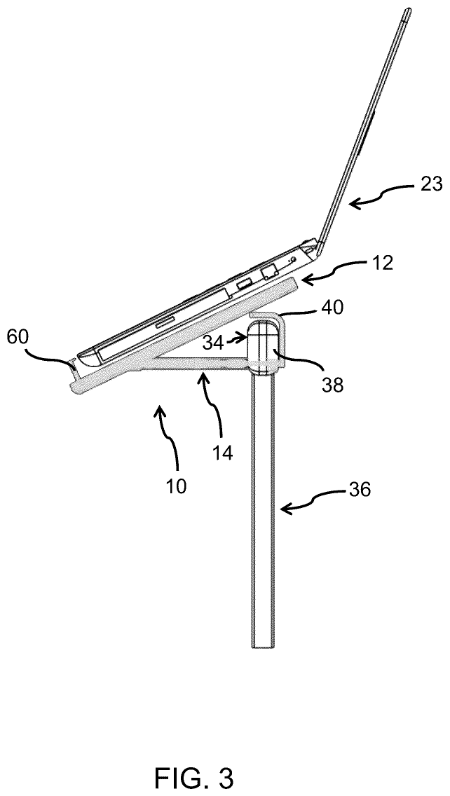

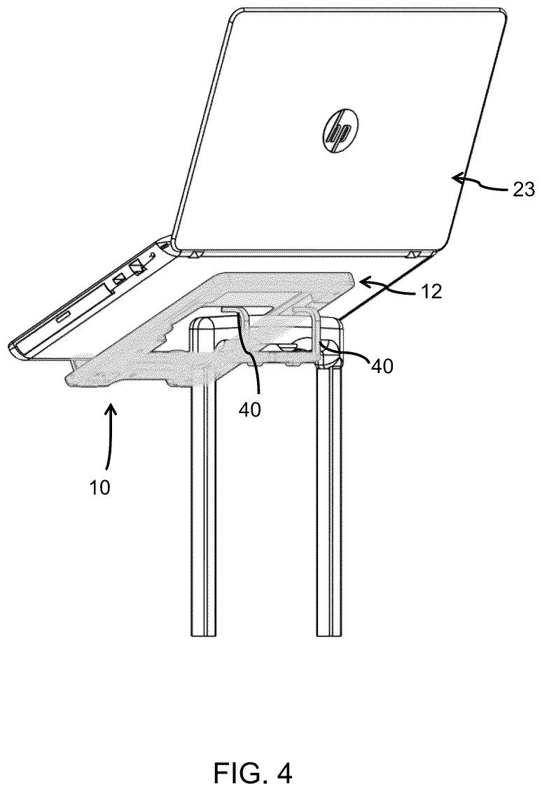

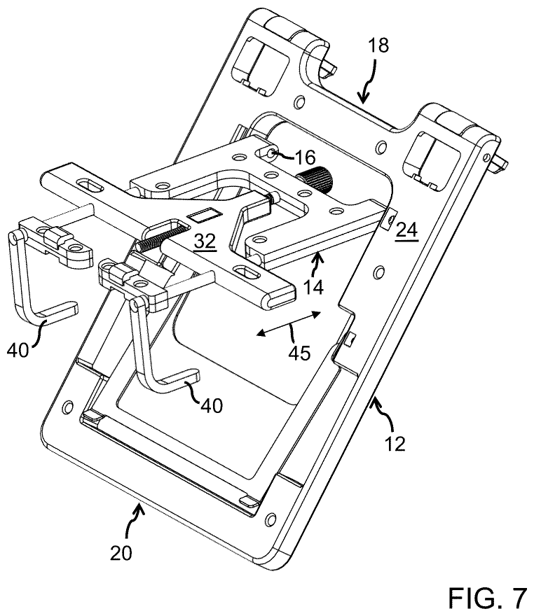

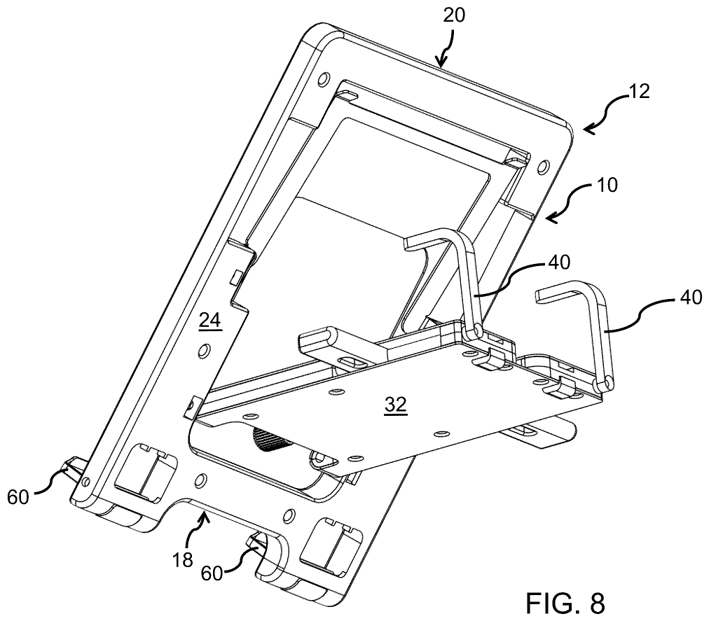

An exemplary mountable device is illustrated in FIGS. 1-12. Referring to FIG. 1, the mountable device generally indicated at 10 comprises a first 12 and second 14 platform connectable at a pivot 16. The first platform 12 comprises first 18 and second end 20 portions and upper 22 and lower surfaces 24. The upper surface 22 may be configured to host an object such as laptop computer or tablet computer thereon generally indicated at 23 as specifically illustrated in FIGS. 3 and 4. The second platform 14 also comprises first 26 and second end 28 portions and upper 30 and lower surfaces 32. The first end 18 of the first platform 12 and the first end 26 of the second platform 14 are pivotally joined at the pivot 16.

As illustrated in FIGS. 1-3, the device 10 is mounted to a mounting surface 34, which is a handle according to FIG. 1. The mounting surface 34 has vertical support members 36 connected at one end by a grip member 38. The second end 28 of the second platform 14 further comprises attachment arms 40 configured to wrap through the mounting surface 34, underneath the grip member 38, and back over a top portion of the grip member 38 (as illustrated in FIGS. 1-4). The upper surface 30 of the second platform 14 engages the grip member 38. The lower surface 24 of the first platform 12 may engage and/or rest on the grip member 38 and/or the attachment arms 40 to support the first platform 12 at an angle and/or providing the first platform with a slope.

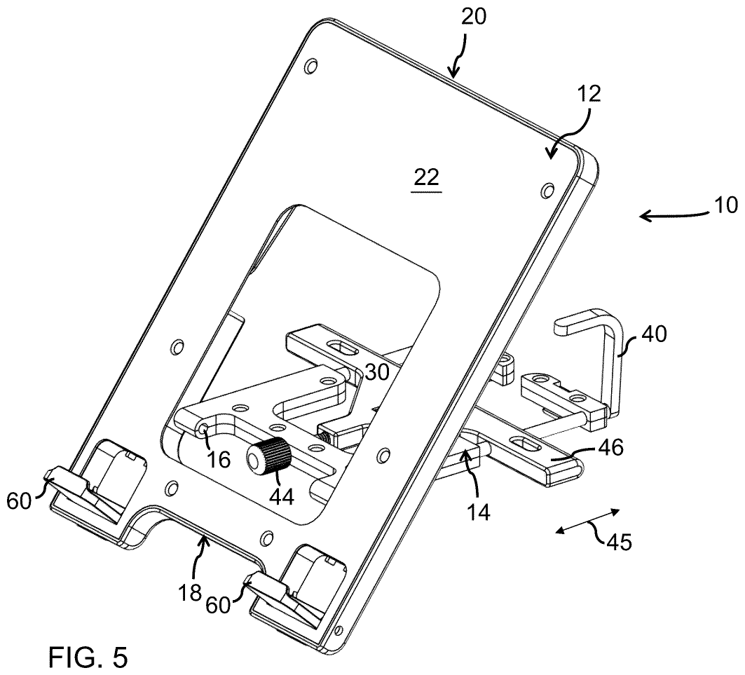

Referring to FIGS. 5 through 8, the mountable device further comprises an adjustment mechanism 42 comprising a threaded rod 44 and clamp 46. The clamp 46 further comprises clamp arms 48. A user may rotate the threaded rod 44, which is exposed on the first end 26 of the second platform 14, to move the clamp 46 and/or the clamp arms 46 along a length of the threaded rod 44 as illustrated by arrows 45. The clamp 46 may be moved toward and from the pivot 16. Referring back to FIG. 1, as the clamp 46 and/or clamp arms 48 are adjusted to move in a direction opposite the pivot 16, the clamp arms 48 eventually engage the grip member 38 and/or vertical support members 36 of the handle. When the clamp arms 48 engage the grip member 38 and/or vertical support members 36, the grip member 38 is tightly secured between the clamp arms 48 and the attachment surfaces 40. Furthermore, when the grip member 38 is tightly secured between the clamp arms 48 and the attachment surfaces 40, the second platform 14 may have a slope of zero or almost zero. Tightly securing the clamp arms 48 with the attachment surfaces induces a slope to the first platform 12 with the first platform 12 pivoting about the pivot 16 at an angle measuring up to 90 degrees.

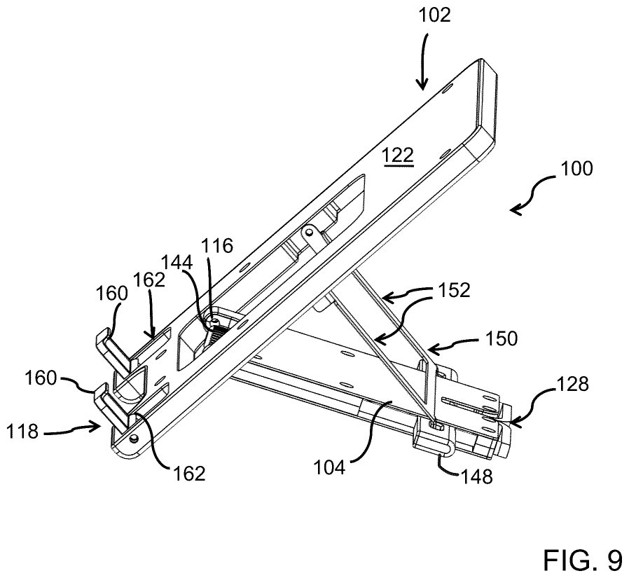

FIG. 9 Illustrates a further embodiment of the device generally indicated at 100 suitable for placement on a substantially flat surface 134. For example, the surface 134 may be a table. The device 100 comprises first 102 and second 104 platforms connectable at a pivot 116. The first platform comprises upper 122 and lower 124 surfaces. The upper surface 122 is configured to host an object such as a laptop thereon. The second platform 114 comprises first 126 and second 128 end portions and upper 130 and lower 132 surfaces. The lower surface 132 of the second platform 114 rests on the mounting surface 134.

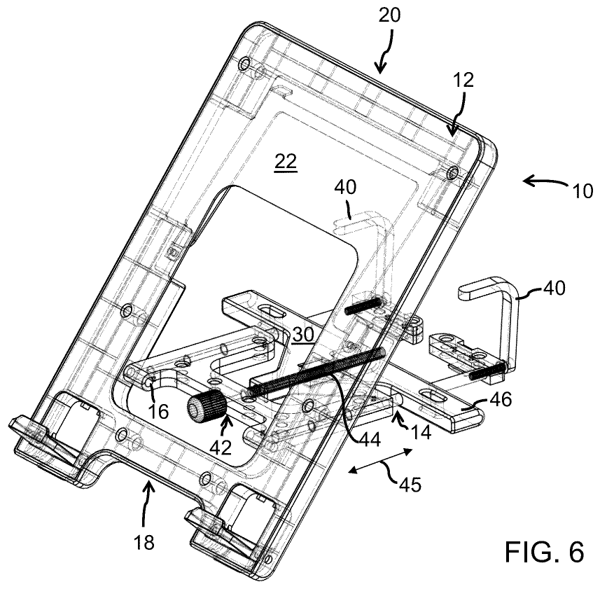

The device 100 further comprises a prop 150 The prop 150 comprises two arms 152 having distal ends which pivotally engage the second platform and are attached to the clamp arms 148 at an end opposite to the distal ends wherein the clamp arms 148 are movable along a plane substantially parallel to the second platform thereby adjusting the angle of the first platform. In more detail the prop 150 is pivotally secured to the first platform 112 and engages the upper surface 130 of the second platform 114 and the clamp 148 via the clamp arms 148. The prop 150 is removably securable to the clamp 146 and/or clamp arms 148 such that, when secured, movement of the clamp 146 along a length of the threaded rod 44 moves the prop 150 along the length of the threaded rod 144 (as discussed with respect to FIGS. 5 and 6). Movement of the clamp, clamp arms, and/or prop may adjust a slope of the first platform 112 and/or an angle measurement of the pivot 116.

As illustrated and discussed with respect to FIGS. 1 through 9, the devices 10 and 100, each have rest tabs 60 and 160, respectively which are pivotally secured to a lower portion of the first platform. The rest tabs, as specifically illustrated FIGS. 3 and 4, are useful in retaining a laptop or a book when the first platform is on a slope, that is the rest tabs prevent the laptop or book from sliding off the first platform. When the devices 10 and 100 are folded the rest tabs since they are pivotally mounted to the first platform are pivotable into spaces 62 as illustrated in FIG. 1 and spaces 162 as illustrated in FIG. 9 within their respective first platforms.

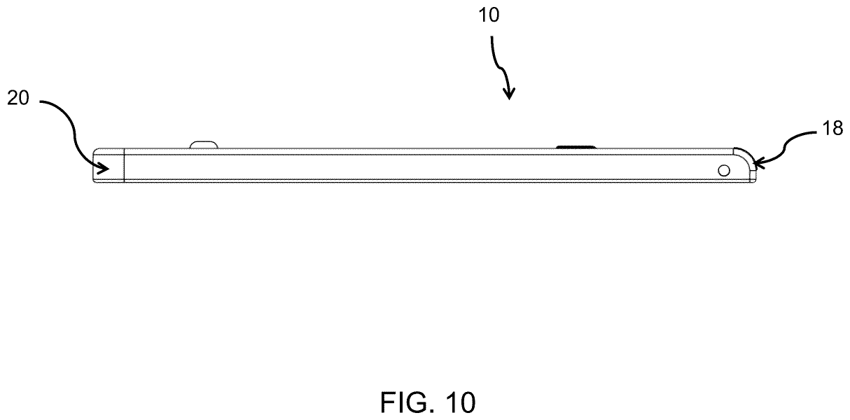

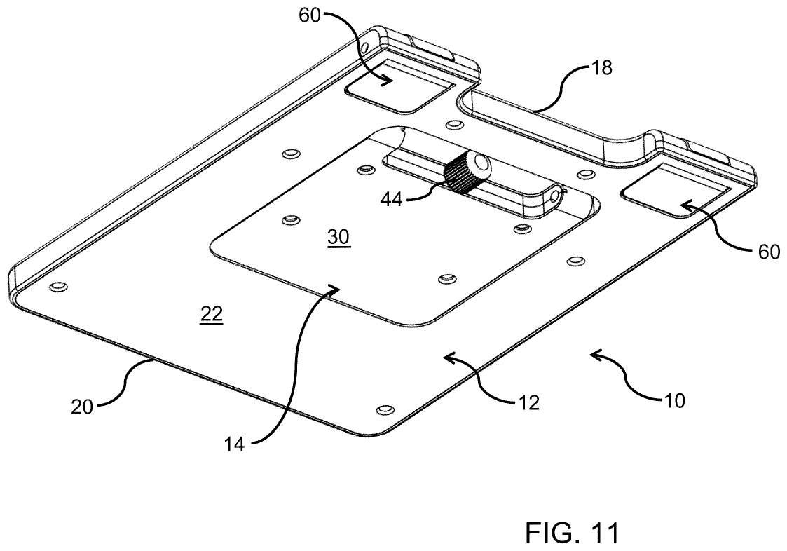

Referring to FIGS. 10 and 11, the device 10 may be folded into a folded configuration such as a nesting position. The first platform 12 and the second platform 14 are configured to nest within each other such that both the first platform and the second platform when folded lie in the same plane. The folded configuration provides for compact packing and portability of the device 10.

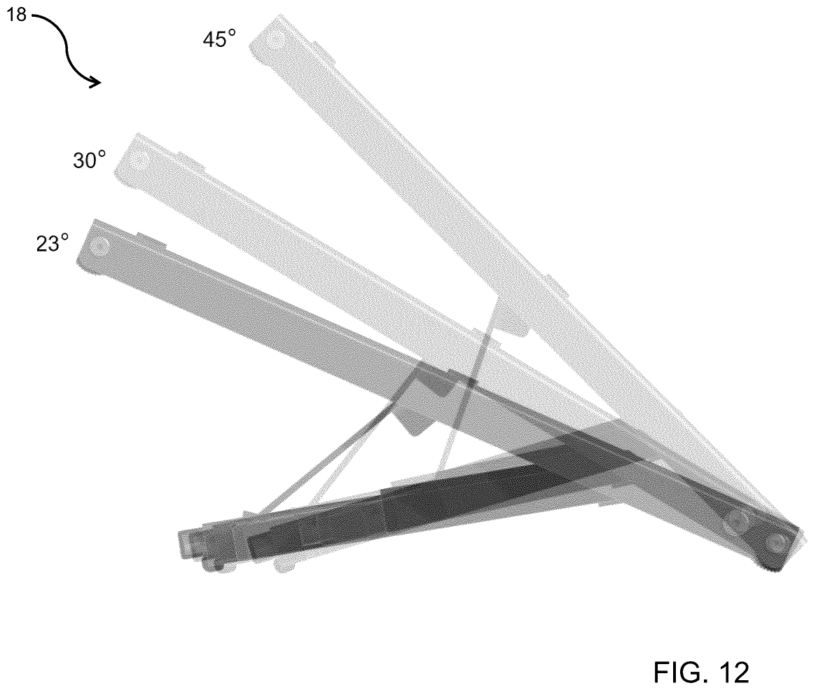

FIG. 12 illustrates the various slopes of the device of this disclosure. Typical slope angles of the device of this disclosure may be but not limited to, 23 degrees, 30 degrees, or 45 degrees. Other slope angles are also attainable as is evident from the description herein. A user may adjust the device as desired.

Although the present disclosure has been described with reference to preferred embodiments, workers skilled in the art will recognize that changes may be made in form and detail without departing from the spirit and scope of the disclosure.

1. A mountable device for use on a handle having two vertical members attached to a grip member at one end, the mountable device comprising:
a pivot;
a first platform having a first end portion and upper and lower surfaces, wherein the upper surface is configured to host an object thereon, the lower surface engages the grip member, and the first end portion is attached to the pivot;
a second platform having first and second end portions, wherein the first end portion is attached to the pivot and the second end portion comprises one or more attachment surfaces configured for mounting the device to the handle by being configured to engage the grip member of the handle thereby forming an angle at the pivot and providing the first platform with a slope; and
an adjustment mechanism comprising a threaded rod and a clamp disposed on the second platform and engaging the lower surface of the first platform, wherein the adjustment mechanism increases or decreases a distance between the clamp and the attachment surfaces thereby increasing or decreasing a slope of the first and/or the second platform.

2. The mountable device of claim 1 wherein the first platform and the second platform comprise aligned apertures and the pivot comprises a rod extending through the aligned apertures of the first platform and the second platform.

3. The mountable device of claim 1 wherein the device further comprises the two vertical members being attached to a carrying article and the adjustment mechanism further comprises clamp arms that are movable between the pivot and a distal end of the first platform such that the clamp arms engage the two vertical members to retain the mountable device to the carrying article.

4. The mountable device of claim 1 wherein the first and second platforms are configured to be nested within each other and are pivotable with respect to each other to a nesting position.

5. A mountable device for use on a flat surface, the mountable device comprising:
a pivot;
a first platform having a first platform end portion and upper and lower first platform surfaces, wherein the upper first platform surface is configured to host an object thereon and the first platform end portion being attached to the pivot, wherein the first platform has a first platform slope;
a second platform having first and second platform end portions and upper and lower second platform surfaces, wherein the first end second platform portion is attached to the pivot and the lower second platform surface is configured for mounting the device to the flat surface;
a prop engaging the lower first platform surface and an upper second platform surface thereby providing the first platform with the first platform slope; and
an adjustment mechanism comprising a threaded rod and clamp disposed on the second platform and engaging the lower first platform surface, wherein the adjustment mechanism increases or decreases a distance between the clamp and the second end second platform portion thereby increasing or decreasing the first platform slope.

6. The mountable device of claim 5 wherein the first platform and the second platform comprise aligned apertures and wherein the pivot comprises a rod extending through the aligned apertures of the first platform and the second platform.

7. The mountable device of claim 1 where in the first and second platforms are configured to be nested within each other and are pivotable with respect to each other to a nesting position.

8. A mountable device for use on a flat surface or, in the alternative, a handle having two vertical members attached to a grip member at one end, the mountable device comprising:
a pivot;
a first platform having a first platform end portion and first platform upper and lower surfaces, wherein the first platform upper surface is configured to host an object thereon and the first platform end portion is attached to the pivot, and wherein the first platform has a first platform slope;
one of:
a second platform having first and second end portions, wherein the first end portion is attached to the pivot and the second end portion comprises one or more attachment surfaces configured for mounting the device to the handle by being configured to engage the grip member of the handle thereby forming an angle at the pivot, wherein the lower surface of the first platform engages the grip member and provides the first platform slope; or
a second platform having first and second platform end portions and second platform upper and lower surfaces, wherein the first second platform end portion is attached to the pivot and the second platform lower surface is configured for mounting the device to the flat surface thereby forming an angle at the pivot; and
an adjustment mechanism comprising a threaded rod and a clamp disposed on the second platform and engaging the lower surface of the first platform, wherein the adjustment mechanism increases or decreases a distance between the clamp and the second end of the second platform thereby increasing or decreasing the first platform slope.

9. The mountable device of claim 8 wherein the first platform and the second platform comprise aligned apertures and the pivot comprises a rod extending through the aligned apertures of the first platform and the second platform.

10. The mountable device of claim 8 wherein the device further comprises the two vertical members being attached to a carrying article and the adjustment mechanism further comprises clamp arms that are movable between the pivot and a distal end of the first platform such that the clamp arms engage the two vertical members to retain the mountable device to the carrying article.

11. The mountable device of claim 8 where in the first and second platforms are configured to be nested within each other and are pivotable with respect to each other to a nesting position.
